(19) United States
(12) Patent Application Publication
(10) Pub. No.: US 2021/0035117 A1
(43) Pub. Date: Feb. 4, 2021

(54) COMPUTER BASED LEARNING SYSTEM FOR ANALYZING AGREEMENTS

(71) Applicant: ISMS Solutions, LLC, Linthicum, MD (US)

(72) Inventor: Anthony N. O'Brien, Linthicum, MD (US)

(21) Appl. No.: 16/639,484

(22) PCT Filed: Aug. 17, 2018
(86) PCT No.: PCT/US2018/000330

§ 371 Date: Feb. 14, 2020

Related U.S. Application Data
(60) Provisional application No. 62/547,561, filed on Aug. 18, 2017.

(51) Int. Cl. G06Q 30/00; G06Q 10/10; G06Q 30/02; G06Q 50/18; G06F 16/903; G06N 20/00; G06F 40/263; H04L 29/08

(52) U.S. Cl. CPC G06Q 30/018; G06Q 10/10; G06Q 30/0203; G06Q 50/18; H04L 67/10; G06F 16/90335; G06N 20/00; G06F 40/263; G06Q 30/01

(57) ABSTRACT

The described system may contain one of more processor based module which attempt to automate the process of verifying that vendors are in compliance with relevant requirements.

### CROSS-REFERENCE TO RELATED APPLICATIONS

This application claims priority to PCT/US18/00330, filed Aug. 17, 2018, which claims priority to U.S. Provisional Application No. 62/547,561, filed Aug. 18, 2017, the disclosure of which is incorporated by reference herein.

### BACKGROUND

Seldom does a business exist which does not require vendors. The relationship between vendors and clients is often governed by contracts. Contracts are often dense documents which have a variety of formats and are written using legalese which is a challenge to understand. In addition, customers often want to be sure that the vendors are following required protocols which are often backed up by documents. For example, if the customer wants to be compliant with a certification organization, the vendors used by the company also have to demonstrate compliance with the certification requirements. Trying to verify that the vendors are following the required protocols or requirements is a significant challenge as collecting the paperwork for verification and actually reading the paperwork takes a significant amount of time and effort.

### SUMMARY

The following presents a simplified summary of the present disclosure in order to provide a basic understanding of some aspects of the disclosure. This summary is not an extensive overview. It is not intended to identify key or critical elements of the disclosure or to delineate its scope. The following summary merely presents some concepts in a simplified form as a prelude to the more detailed description provided below.

The described system may contain one of more processor based module which attempt to automate the process of verifying that vendors are in compliance with relevant requirements. The system may communicate a self-assessment request to a vendor and the system may receive a self-assessment response from the vendor. In response to the self-assessment determined to be acceptable, the system may determine whether the vendor is due for a random audit. In response to the random audit being determined to be due, the random audit may begin which may entail receiving contracts, reviewing contracts, noting exceptions and updating a customer user dashboard. In response to the random audit not being determined to be due, the customer user dashboard may be updated. Whether the self-assessment is determined to be acceptable may take on a variety of forms. In some embodiments, a simple word comparison may be used. Logically, the determination may be more complex and the system may learn from past contracts to better understand whether future contracts are in compliance with the relevant requirements.

### BRIEF DESCRIPTION OF THE DRAWINGS

The invention may be better understood by references to the detailed description when considered in connection with the accompanying drawings. The components in the figures are not necessarily to scale, emphasis instead being placed upon illustrating the principles of the invention. In the figures, like reference numerals designate corresponding parts throughout the different views.

FIG. 1 is a high level illustration of a system flow according to the claims of the application;

FIG. 2 is an illustration of sample blocks for a first time user of the system;

FIG. 2a is an illustration of a get started page for a customer;

FIG. 2b is an illustration of a license agreement page for a vendor;

FIG. 2c is an illustration of a create account user interface for a customer;

FIG. 2d is an illustration of a user interface to add customer information;

FIG. 2e is an illustration of a user interface to add vendors;

FIG. 3 is an illustration of sample blocks for a returning user of the system;

FIG. 3a is an illustration of a sign in page for a returning customer;

FIG. 3b is an illustration of dashboard for a returning customer after logging in successfully;

FIG. 3c is an illustration of a user interface for reviewing company information;

FIG. 3d is an illustration of a user interface for reviewing vendor information;

FIG. 3e is an illustration of a user interface for selecting an assessment for a vendor;

FIG. 3f is an illustration of a user interface for adding a vendor;

FIG. 3g is an illustration of a user interface for reviewing vendor assignments;

FIG. 3h is an illustration of selecting a catalog for a vendor;

FIG. 3i is an illustration of previewing an assignment for a vendor;

FIG. 3j is an illustration of a user interface for adding a completion date for a vendor assignment;

FIG. 3k is an illustration of a user interface for reviewing vendor scores after assessments are complete;

FIG. 4 is an illustration of sample blocks for a first time vendor of the system;

FIG. 5 is an illustration of sample blocks for a returning vendor of the system;

FIG. 6 is an illustration of computing levels of the system;

FIG. 7 is an illustration of a sample flow of the system from the company, vendor and system perspective; and

FIG. 8 shows an exemplary computing device that may be physically configured to execute the methods described herein.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meanings have otherwise been set forth herein.

### SPECIFICATION

The present invention now will be described more fully with reference to the accompanying drawings, which form a part hereof, and which show, by way of illustration, specific exemplary embodiments by which the invention may be practiced. These illustrations and exemplary embodiments are presented with the understanding that the present disclosure is an exemplification of the principles of one or more inventions and is not intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods, systems, computer readable media, apparatuses, or devices. Accordingly, the present invention may take the form of an entirely hardware embodiment, an entirely software embodiment, or an embodiment combining software and hardware aspects. The following detailed description is, therefore, not to be taken in a limiting sense.

Seldom does a business exist which does not require vendors. The relationship between vendors and clients is often governed by documents such as contracts. Contracts are often dense documents which have a variety of formats and are written using legalese which is a challenge to understand. In addition, customers often want to be sure that the vendors are following required protocols which are often backed up by documents. For example, if the customer wants to be compliant with a certification organization, the vendors used by the company also have to demonstrate compliance with the certification requirements. Trying to verify that the vendors are following the required protocols or requirements is a significant challenge as collecting the paperwork for verification and actually reading the paperwork takes a significant amount of time and effort.

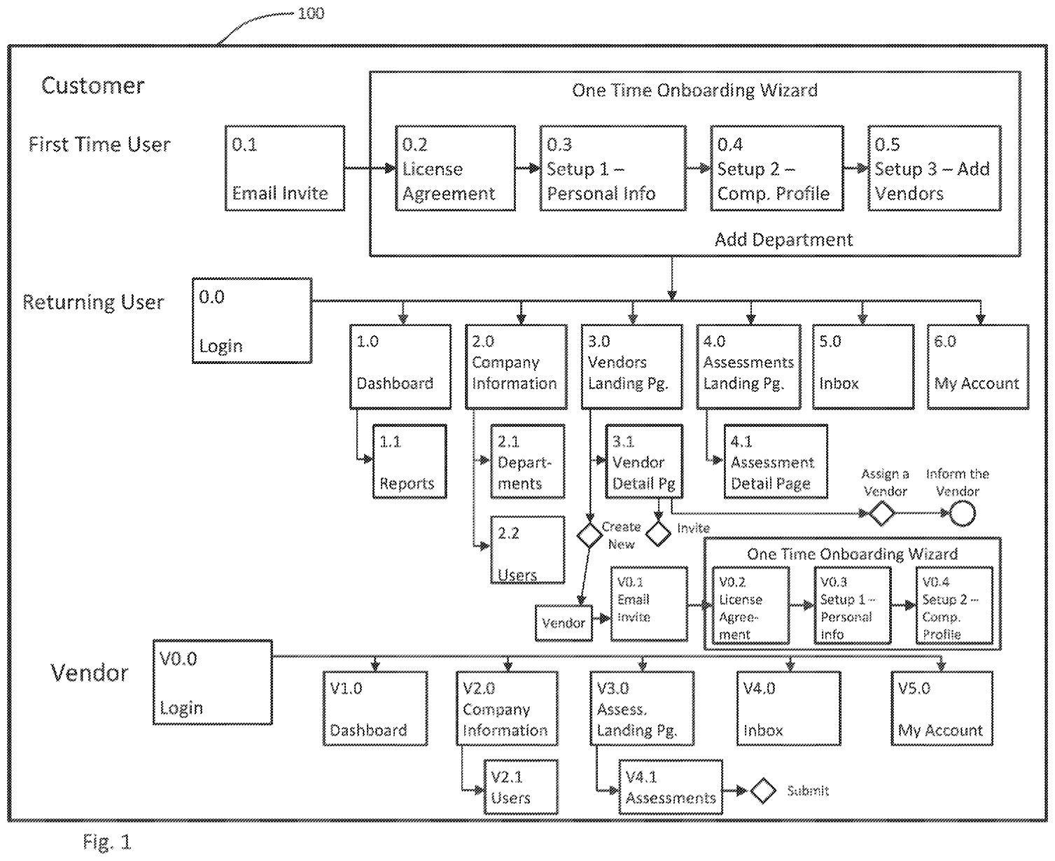

The described system 100 illustrated in FIG. 1 may contain one of more processor based module which attempt to automate the process of verifying that vendors are in compliance with relevant requirements. The system may communicate a self-assessment request to a vendor and the system may receive a self-assessment response from the vendor. In response to the self-assessment determined to be acceptable, the system may determine whether the vendor is due for a random audit. In response to the random audit being determined to be due, the random audit may begin which may entail receiving contracts, reviewing contracts, noting exceptions and updating a customer user dashboard. In response to the random audit not being determined to be due, the customer user dashboard may be updated. Whether the self-assessment is determined to be acceptable may take on a variety of forms. In some embodiments, a simple word comparison may be used. Logically, the determination may be more complex and the system may learn from past contracts to better understand whether future contracts are in compliance with the relevant requirements.

The system and methods which operate on the system address several technical problems. First, for many corporations have a large number of vendors and even more contracts which have to be reviewed. If there are issues, then follow up is required. Using humans to undertake this task takes a significant amount of time and is prone to errors. The system uses rules to review the documents such that errors will be minimized. Further, the rules may be improved over time by using algorithms to technically analyzed previous documents and learn from them. Finally, blockchain storage methods may be used to communicate and track the documents and results.

The system 100 may operate over a network. The network may be described variously as a communication link, computer network, internet connection, etc. The system 100 may include various software or computer-executable instructions stored on tangible memories and specialized hardware components or modules that employ the software and instructions to securely facilitate managing the in-store inventory and transaction process within a checkout-free store of a merchant, as described herein.

The various modules may be implemented as computer-readable storage memories containing computer-readable instructions (i.e., software) for execution by one or more processors of the system 100 within a specialized or unique computing device. The modules may perform the various tasks, methods, modules, etc., as described herein. The system 100 may also include both hardware and software applications, as well as various data communications channels for communicating data between the various specialized and unique hardware and software components.

Referring to FIG. 1, the system 100 control a flow for customers/users and for vendors. At a high level, customers may select that vendors to be invited to use the system and may monitor the vendors progress through the process. Vendors may receive an invitation to be part of the system and may add the relevant data and documents such as upload documents to the system to be analyzed. The vendors may view their status in the system and may be able to update the data in the system.

At a high level, the system 100 may work as follows:
Vendors may address a set of applicable controls by directly answering questions over their level of conformance with each control.
The applicable controls may be derived by the answers provided in vendor surveys/questionnaires.
Vendor workflow may require the vendors to upload documents which may be called upload documents in complying with their applicable controls.
As part of vendor's scoring, the relevance of the upload documents may assessed with respect to the controls they target.
Additionally, in terms of scoring methodology:
   Controls may be defined as mandatory or optional as objective;
   Controls may have a mandatory document upload requirement;
   A single document can address upload requirements for multiple controls; and
   Controls may be associated with weights in terms of prioritization or penalties in terms of the failure to meet the conformance criteria.

At a high level, the approach may use a search-inference framework to assess the relevance of an upload document to address an associated control objective. In such search scenario:
Each control may be associated with a normalized search query which may be defined in terms of relevant terms, phrases, concepts, and in more advanced stages simple relations captured as subject-predicate-object tuples.
The match score of an upload document with its associated control query may be a measure of the upload document's relevance.
In case the relevance score is below a threshold (including the lack of a document uploaded in the first place), the match over the control-query may be expanded to all upload documents uploaded by the vendor however relevance score would incur a penalty.

At a high level, the matching of upload documents may take a simplistic form and may become more sophisticated.
1. BASELINE SEARCH without external ontologies: May match on exact terms, n-ary expressions (phrases) avoiding stop-words
2. ENHANCED SEARCH without external ontologies: May match with query expansion incorporating the following:
   Search incorporating stemming;
   Search incorporating synonyms, preferred forms; and
   Search incorporating spelling errors.
3. ENHANCED SEARCH with external ontologies: May match with queries incorporating concepts and simple relations such as incorporating broader and narrower sense of terms. This stage may require the creation of ontologies and their incorporation into No-SQL Database. Some examples include:
   Manual thesaurus incorporating broader (generic), and narrower (specific) terms in addition to the preferred terms and synonyms
   Controlled vocabulary with a canonical term for each concept
   Auto-generated thesaurus based on co-occurrence statistics

As large vendor document-bases are acquired in no-sql database for advanced analytics, mining, and learning, it may be possible to devise more advanced inference features in support of scoring and document-relevance assessment, going beyond the scope of search methods such as:
Term occurrence analysis and weight assignment to certain terms for documents deemed relevant per associated control type;
Concept linking which goes beyond the matching on broader/narrower sense of terms/phrases (is-a relationship) and involves finding known associations per control type (utilizes NLP techniques i.e. POS tagging, entity recognition in the text content);
Clustering for discovering similar documents (including the assessment of relevance as a feature), on the fly and creating a vector of topics which can be used to measure the relevance of new documents;
Mining for association rules, concept correlation in large data sets; and
Deep Learning

First Time Customer Onboarding

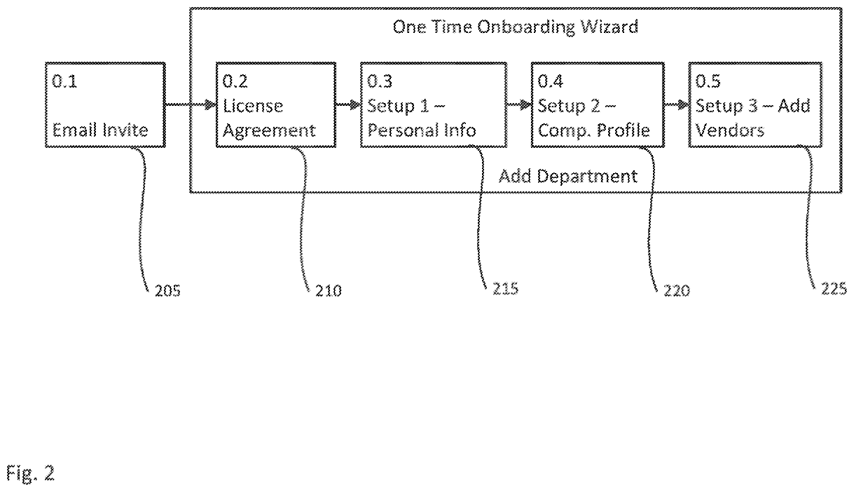

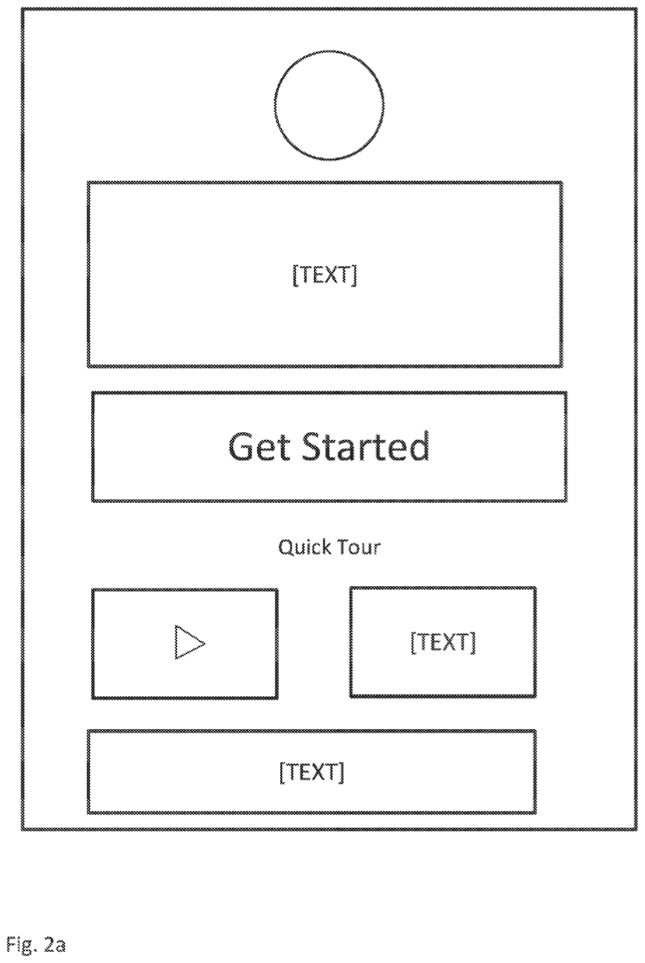

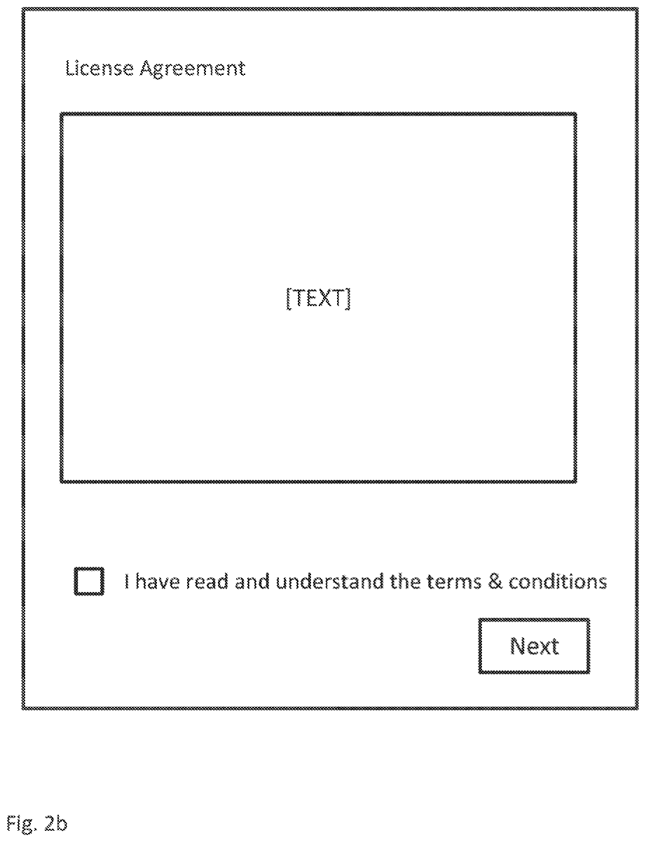

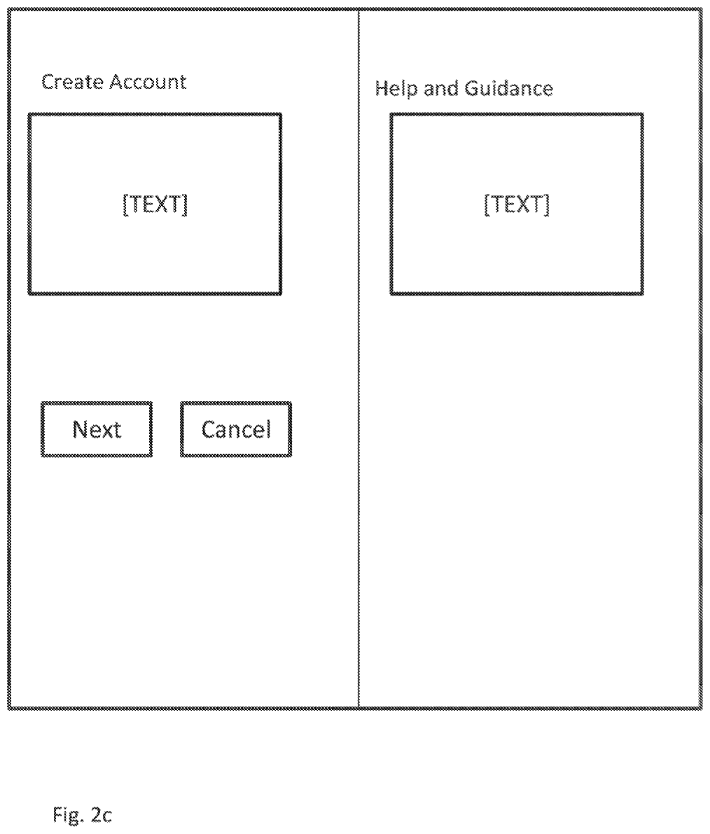

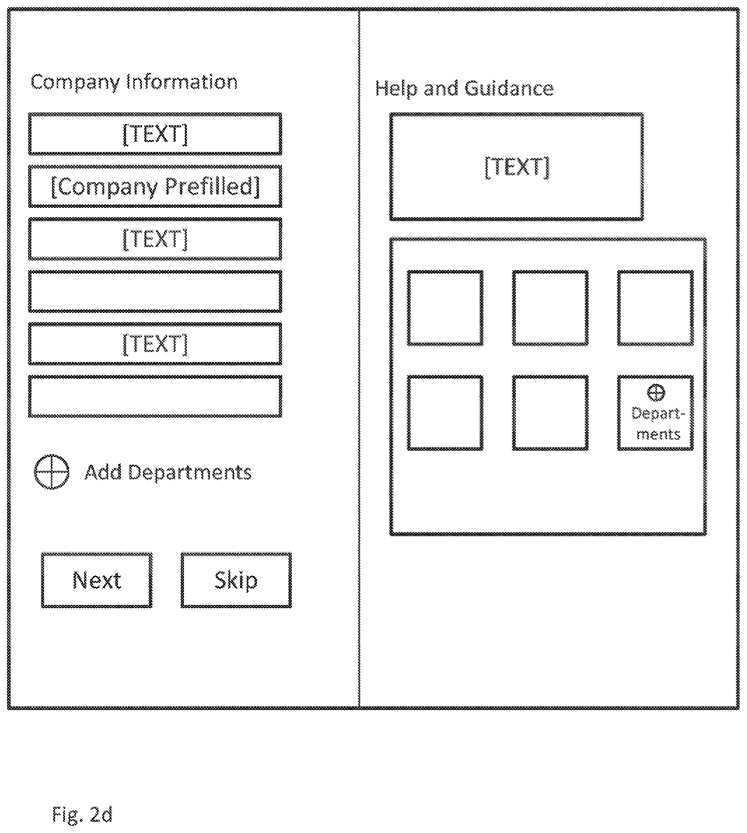

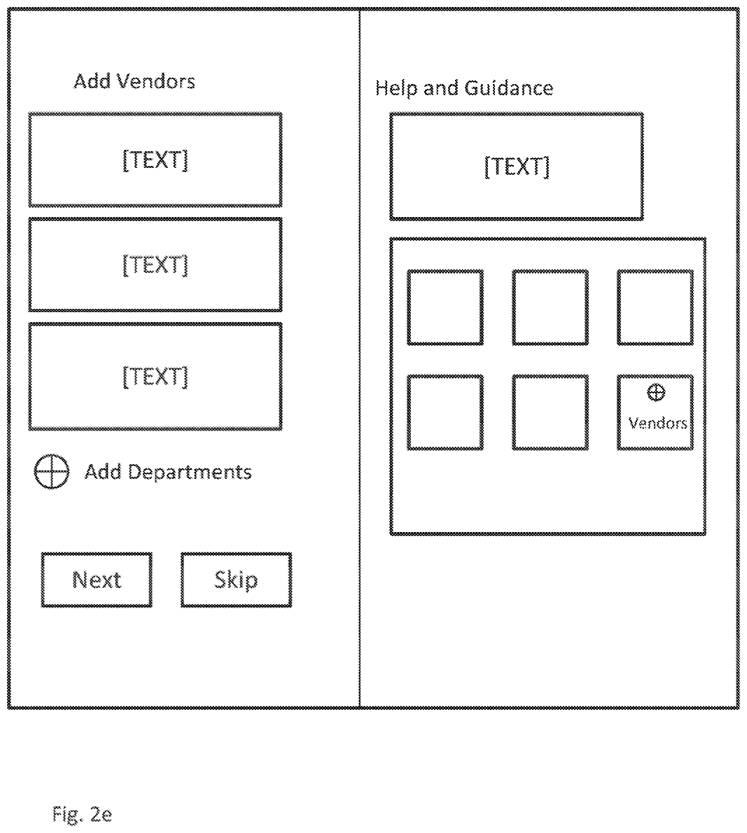

Referring to FIG. 2, a customer or user first using the system may first need to set up the company in the system. The customer may find the system in a variety of ways. In some situations, the customer may have sought out the solution to the technical problem of managing a large number of contracts. In other embodiments, the customer may have received an email invitation 205 to try the system such as illustrated in FIG. 2a.

Once the customer accepts the invitation, a one time on-boarding process may being. A wizard or simple guided set up may be used to make the onboarding process easier. The customer may be presented a license agreement 210 which may be reviewed and accepted by the customer such as illustrated in FIG. 2b. If the license is not accepted, the onboarding process may end. If the license is accepted, information on customer may be requested 215 to create an account by adding information such as addresses, user names and passwords and an account as illustrated in FIG. 2c. A comprehensive profile 220 may occur which may include gathering additional information about the customer and the needs of the customer such as whether all agreements and contracts contain arbitration clauses or indemnity clauses as illustrated in FIG. 2d. At block 225 and as illustrated in FIG. 2e vendors of the customer may be added such that the customer may communicate messages to the vendors that materials such as contracts and agreements needs to be added to the system such that the customer can verify the vendor is in compliance with relevant rules set by the customer. A user may skip this step and perform this task once he/she is in the application. A user interface including a side bar may familiarize user with the vendor functionality.

In some embodiments, some of the later steps such as 215, 220 or 225 may be optional, but the steps may be presented to the user to educate them about the application basic setup. A user may skip these steps but may be presented the navigation to update these information later.

Existing Customer

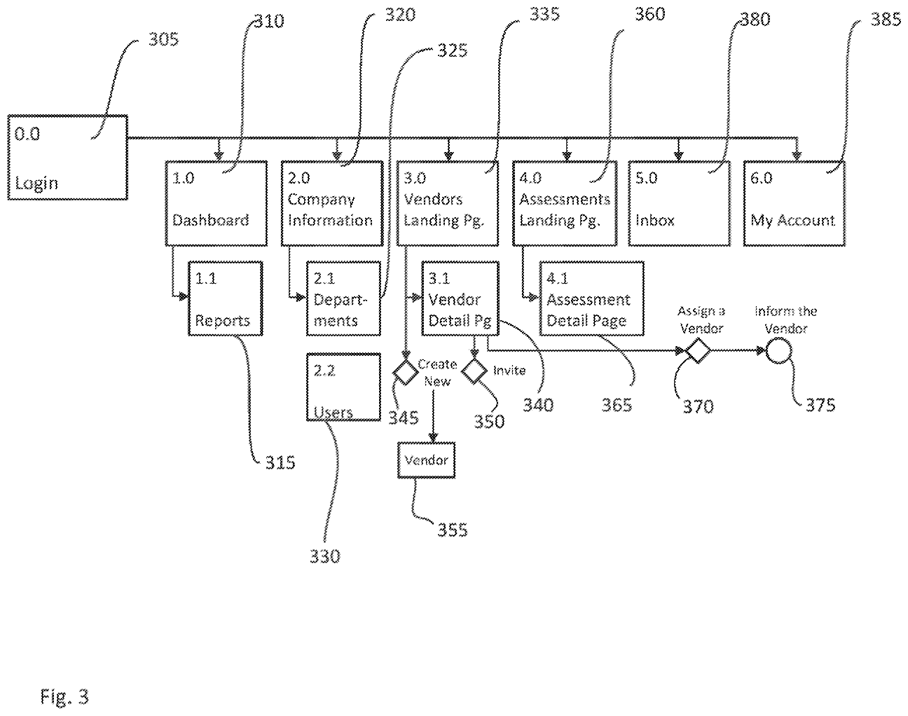

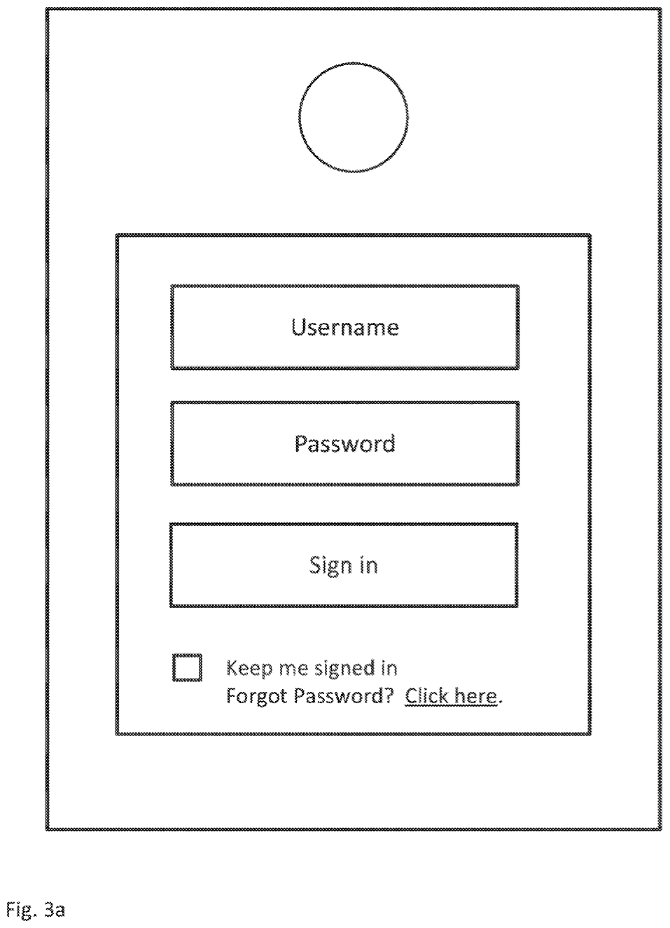

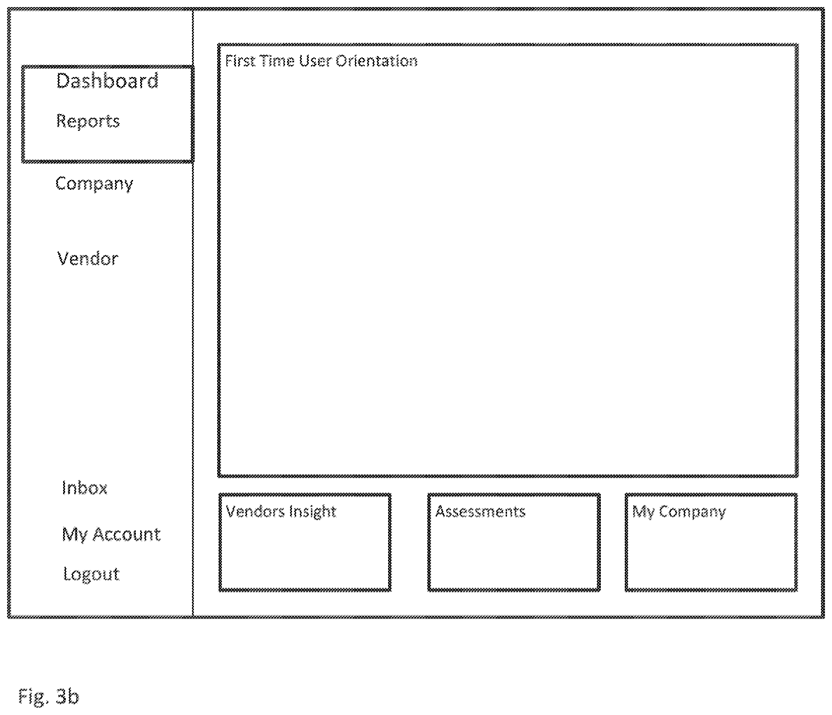

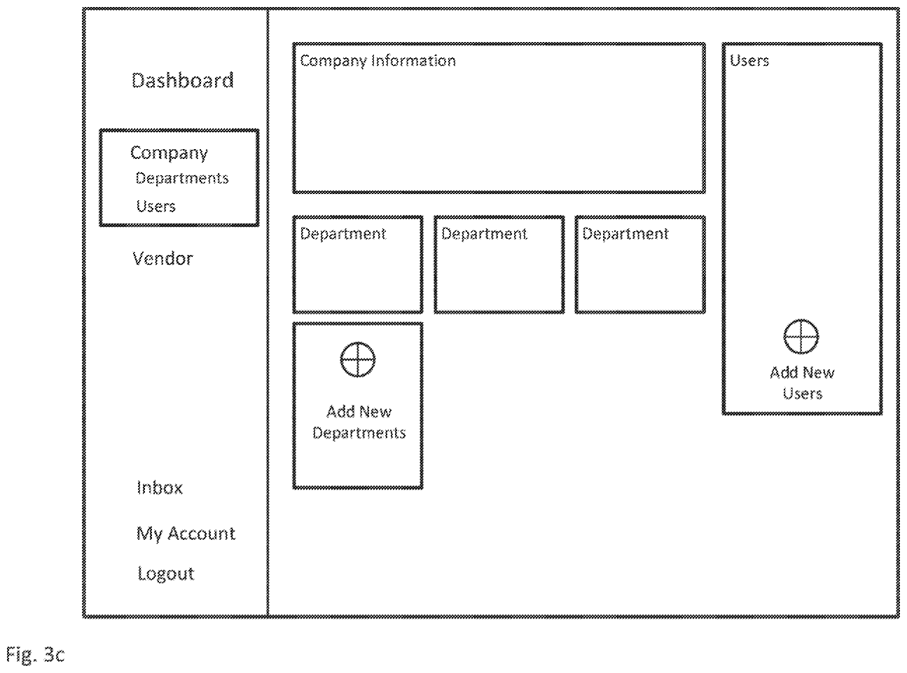

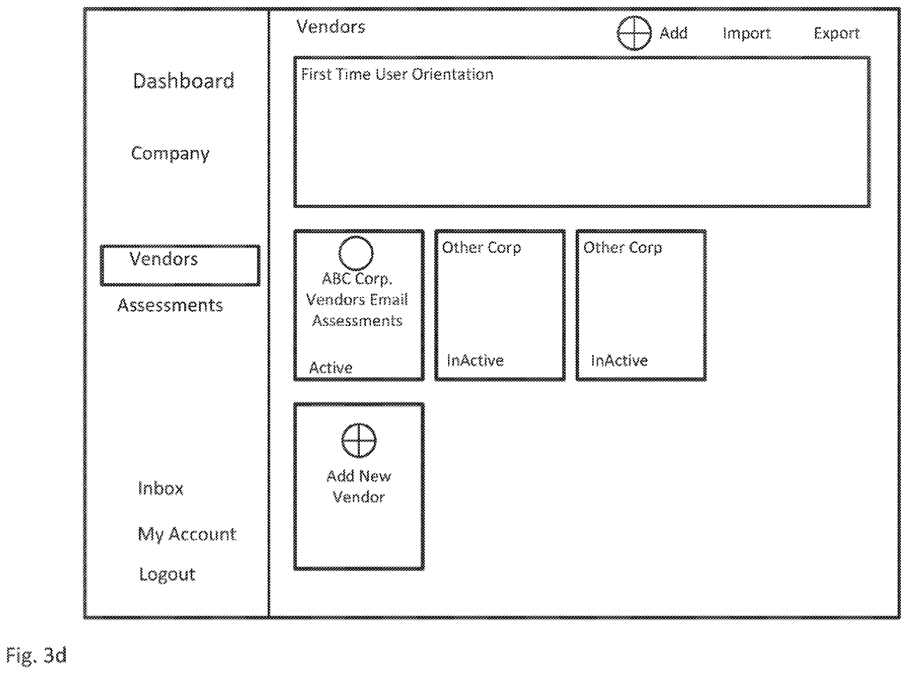

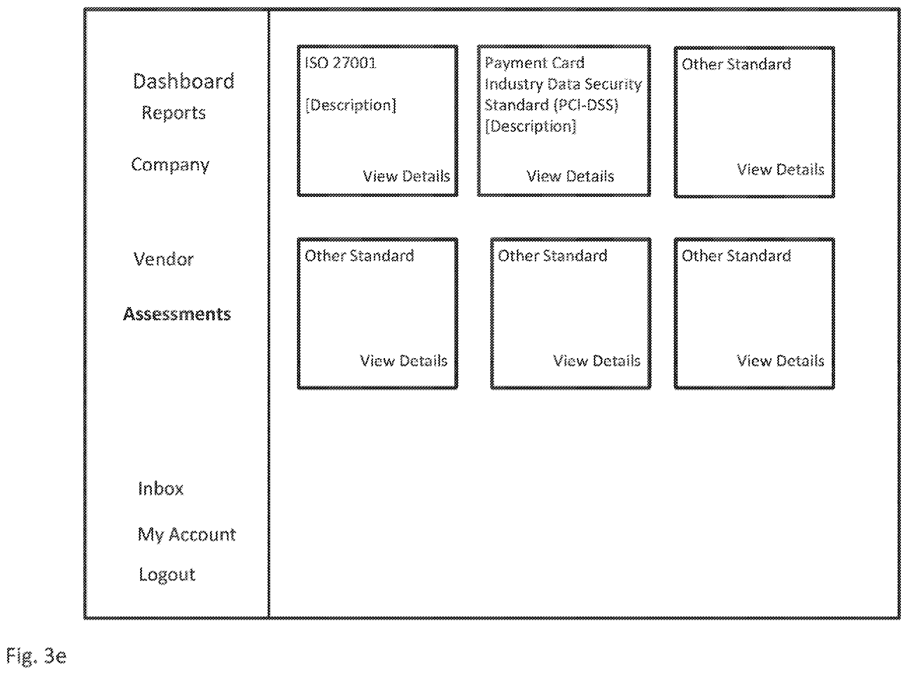

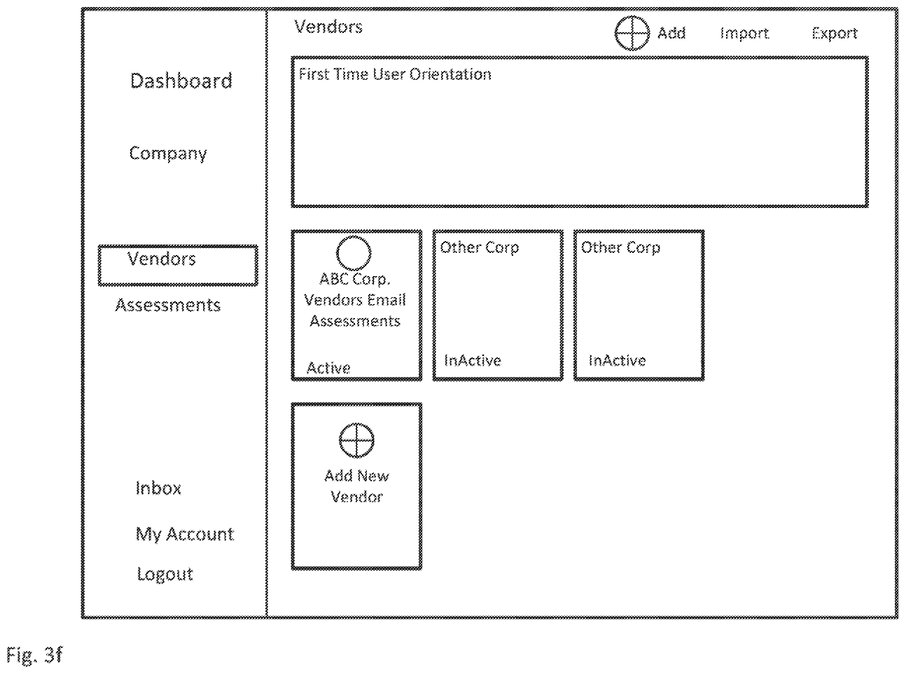

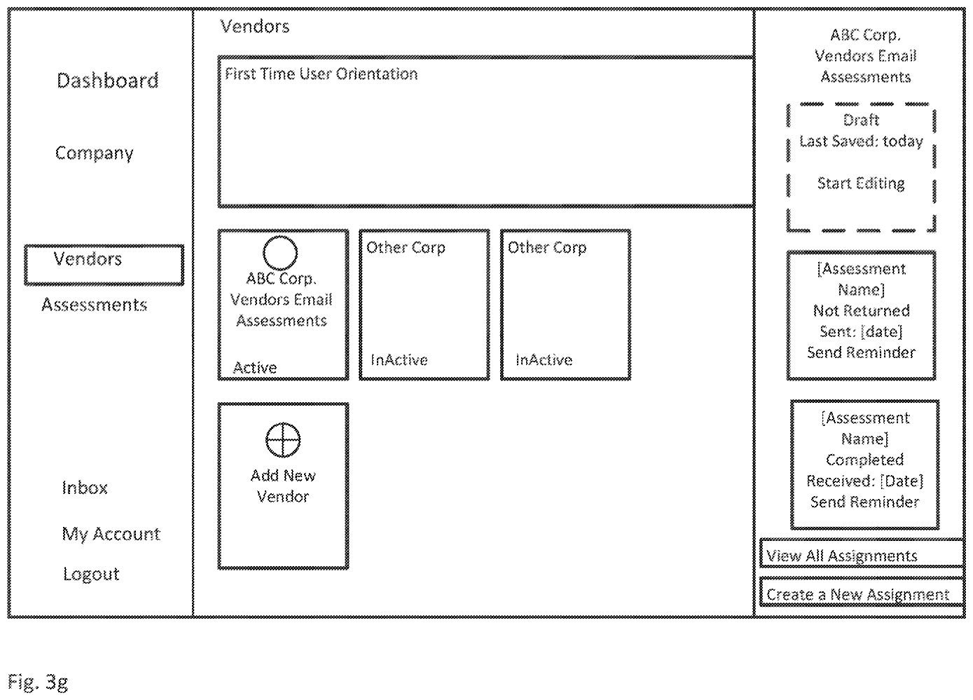

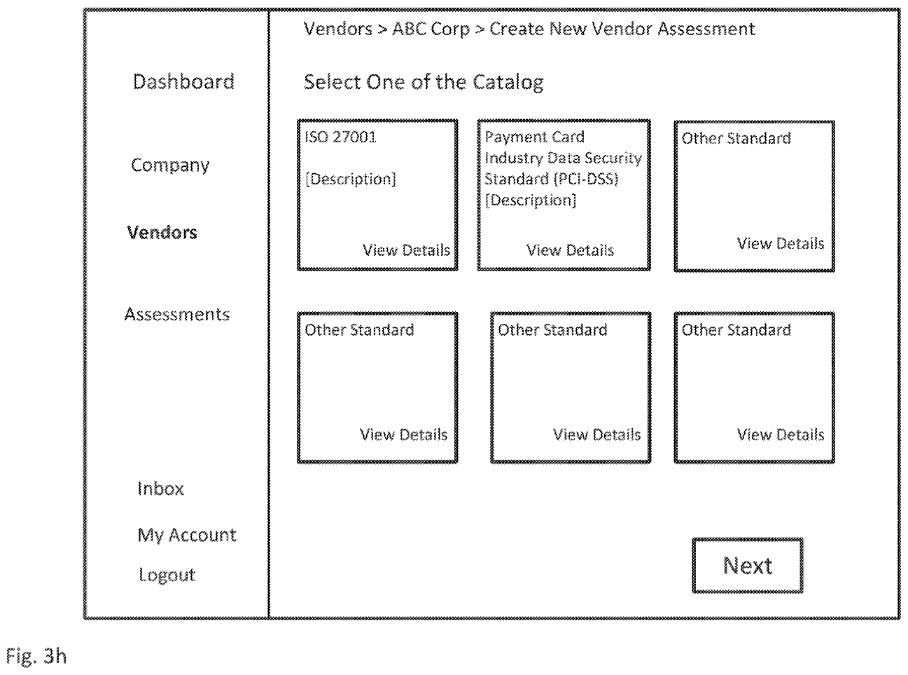

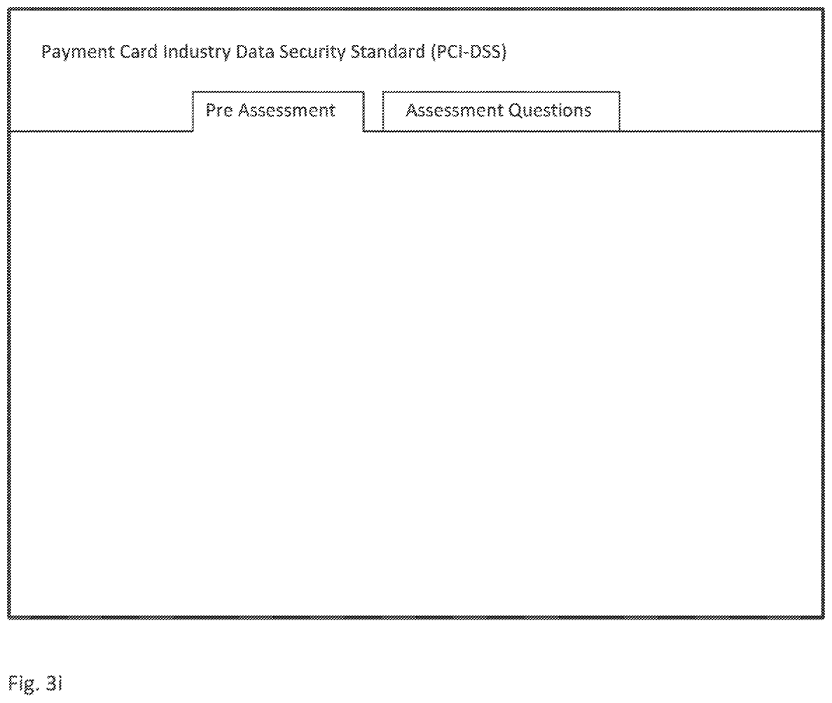

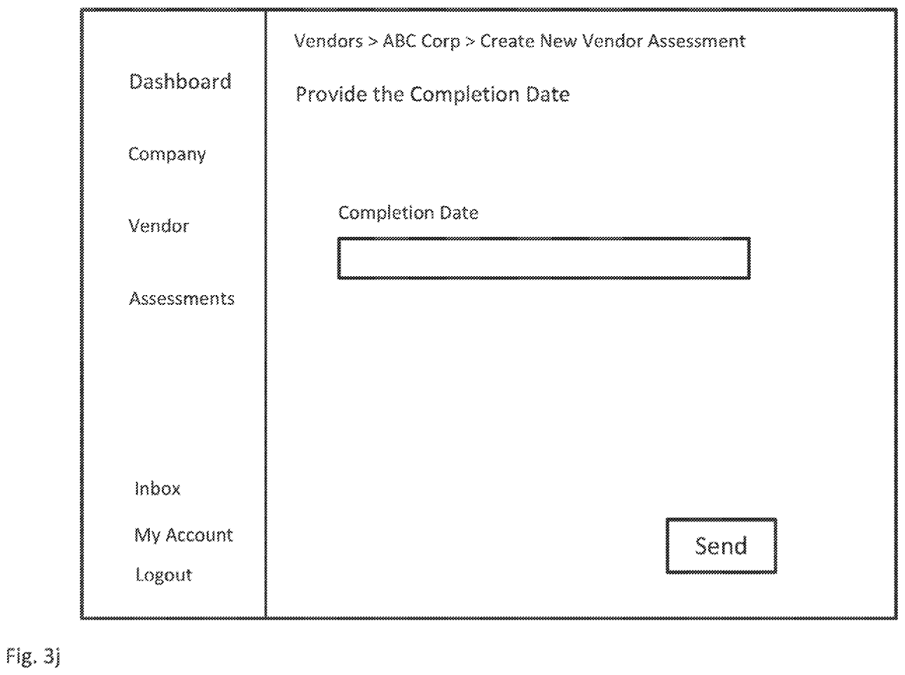

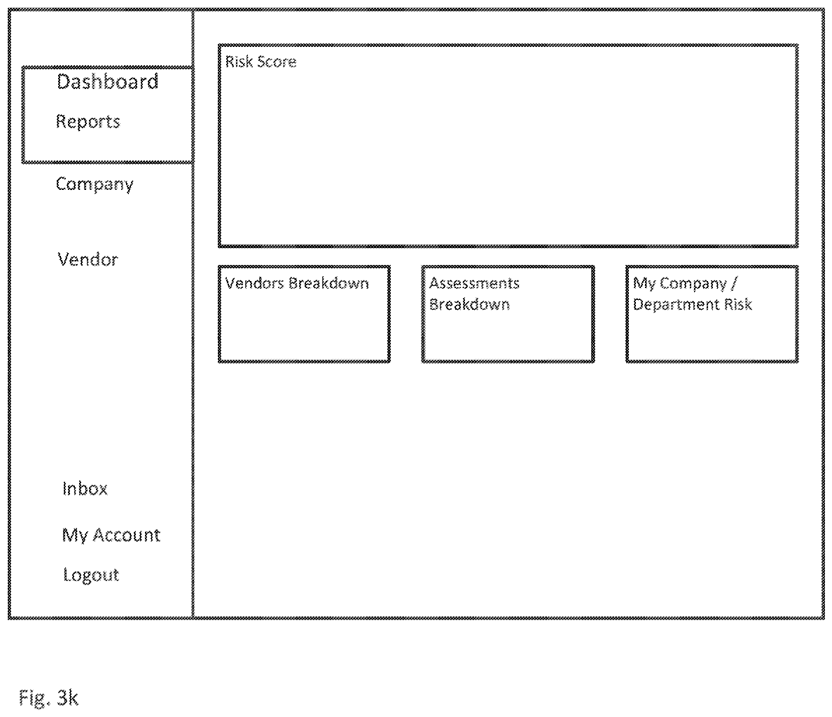

In some scenarios such as illustrated in FIG. 3, a customer may already be a user of the system. Thus, a returning customers will sign in to the application 305 as illustrated in FIG. 3a by entering the credentials they established during onboarding described briefly in FIG. 2. Once inside the application, the customer may be presented with help and guidance to get started quickly in the key tasks. They may also be presented with very intuitive and easy to follow task model (navigation et al.) as illustrated in FIG. 3b. User may be navigated inside the application to complete the setup—in this case, building the company profile and defining the organization (Department, et al.) as illustrated in FIG. 3c. Users may also quickly add the Vendor's either manually as illustrated in FIG. 3d, or by importing the formatted list. This process will also help educate users about managing vendors profile in the system before they start the assessment.

Based on the setup with individual customer, each customers may be provided with set of assessment questionnaire (aka Catalogs) as illustrated in FIG. 3e. Customers may view the assessments, but initially the customers may not be able to modify and create new catalogs.

Various options may be presented to the customer once the customer has logged into the system. A dashboard 310 may be presented which may have a summary of the present status of the vendors in the system. Various reports may be available at block 315 for quick viewing. The reports may be standard reports or may be reports that are created by the customer. The reports may summarize any aspect of the system that is of interest to the customer.

At block 320, the customer may also be able to review information that has been previously entered into the system. For example, the company information may be available to be reviewed and edited, such as the department breakdown at block 325 and the users and the permissions available to the various users 330.

At block 335, the customer may also be able to review vendor details on a vendor landing page as illustrated in FIG. 3f. User may also be able to view all about this vendor in one place at block 340 and as illustrated in FIG. 3g. By selecting the name, he/she may be presented with the Vendor Detail page, that may include Vendor, Company, Assignment (due & past items), etc. The customer may be able to view vendor details assuming some of the vendor details are in the system. If the vendor is not in the system, the vendor may be created in the system at block 345. If the vendor is in the system but has not been asked to join the part of the system that tracks adherence to rules, at block 350 an option to communicate an invitation to the vendor may be available. Either the creation of the new vendor request for data or the invite to join the assessment system may be communicated to the vendor at block 355 which may be described in relation to FIG. 3g.

An assessment landing page 360 also may be available. This scenario describes how user may send an assessment to a vendor from “vendor” tab. This scenario assumes that user's has already established Vendors in the system and her/his goal is to send the assignment to complete an assessment to a vendor and watch the progress. The customer may be able to view the assessment detail for each vendor at block 365. As illustrated in FIG. 3g, a customer may review the past assignments, currently in assignment in process or if there was an assignment in progress (but not sent to the vendor). As illustrated in FIG. 3h, the customer may also create a new assignment at block 370 and the assignment may be communicated to the vendor at block 375. Before sending the assignment, the user may want to preview the details of the assignment before communicating the assessment to the vendor as illustrated in FIG. 3i. The user may assign a completion date to the assignment as illustrated in FIG. 3j. Once sent, progress and reminders are tracked against this date. Once user has completed the task of sending the assignment, the user may be able to keep track of this assignment from Dashboard as well as from the Vendor's detail page as well as illustrated in FIG. 3k.

The User may also have an inbox 380 to receive messages from vendors. In addition, at block 385 the user may have the ability to check on their account such as the time left on a subscription, the number of vendors that are using the system, the dates upcoming for vendor responses, overall responses, etc.

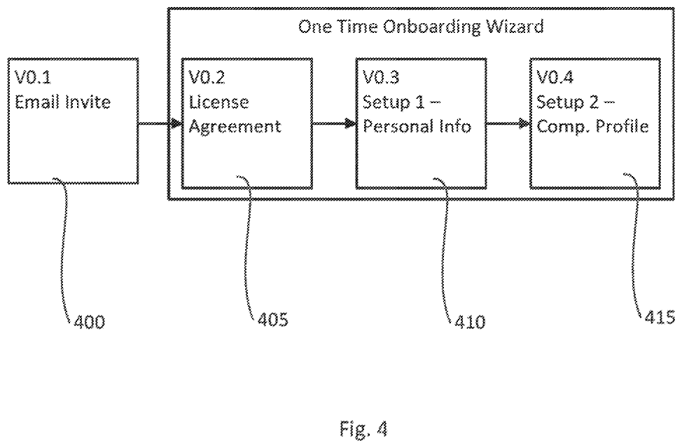

Referring to FIG. 4, from a vendor perspective, if the vendor is new to the system, the vendor may have a separate logical flow. The vendor may receive an email invite at block 400 to use the system to track assignment of assessments. Once the vendor accepts the invitation, the vendor may have to accept a license agreement at block 405. Once the license agreement has been accepted, the vendor may input the personal information for the vendor at block 410 and may set up a profile for the vendor at block 415. The user interface may use a wizard to assist the vendor in setting up the system.

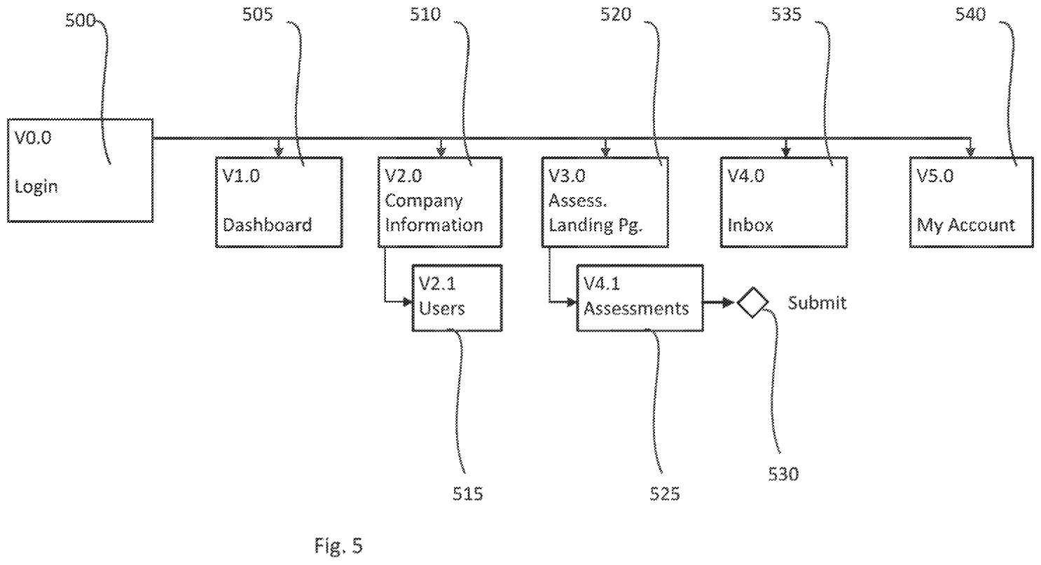

If the vendor is a returning user of the system 100, the flow of FIG. 5 may be used and the vendor may log into the system at block 500. The vendor may then view a dashboard at block 505 which may contain status and updates for the vendor. The vendor may also see company information 510 and information on users and permissions of the users at block 515. The vendor may also have an assessment landing page at block 520 which may contain information on ongoing assessments 525 and whether assessments are ready to be submitted at block 530. The vendor may also have an inbox 535 to receive notifications from the system and from the user. The vendor may also have access to their account at block 540 where they can review their status, any fees upcoming, any deadlines, etc.

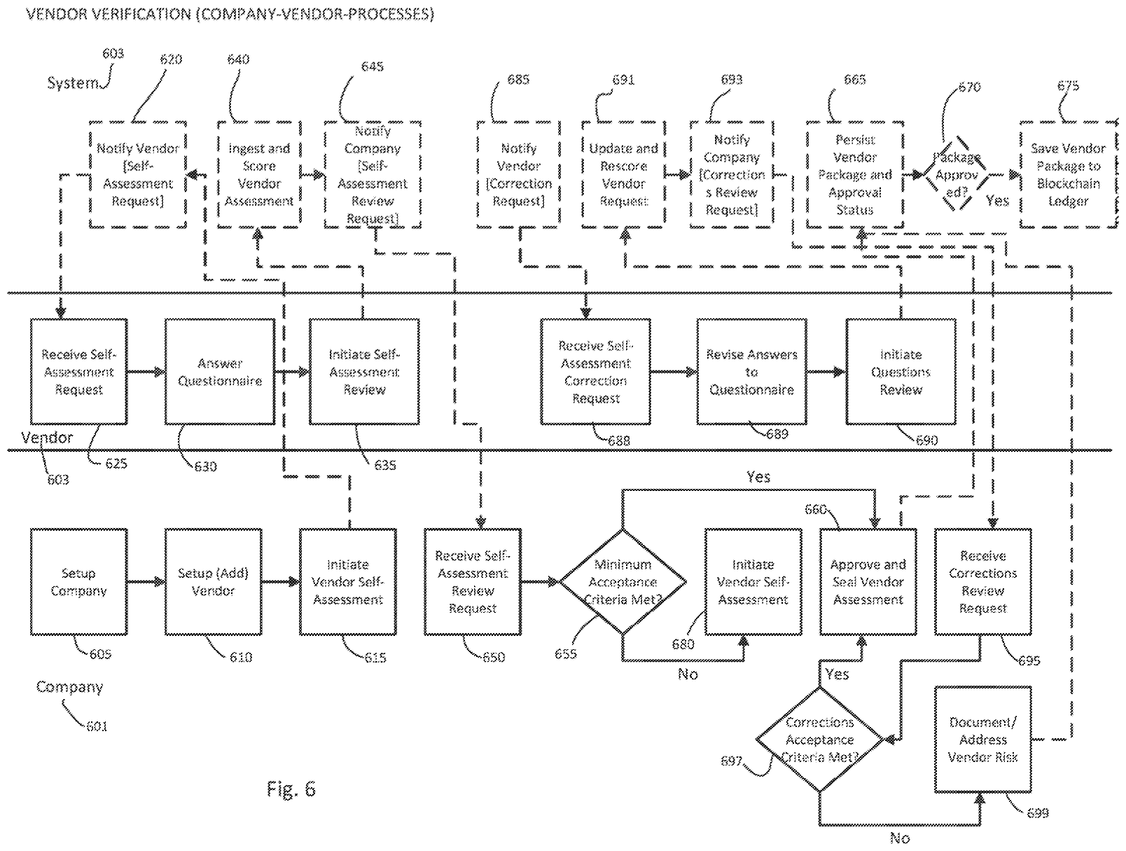

Referring to FIG. 6, an illustration of a sample flow of the system 100 from the perspective of the company 601, the vendor 602 and the system 603 may be disclosed. At block 605, a user may set itself up in the system. At block 610, a vendor may then be added by the user. At block 615, the user may communicate an invitation to the vendor to use the system and provide assessment materials to the system. At block 620, The system may communicate the self-assessment request to the vendor. At block 625, the vendor may receive the self-assessment request and answer the questionnaire at block 630. At block 635, the vendor may start the self-assessment review by submitting the requested materials.

At block 640, the system may ingest and score the materials from the vendor. At block 645, the system may then communicate the self-assessment results to the user. At block 650, the user may receive the analysis from the system and may decide whether the assessment meets the minimum assessment criteria at block 655. If the self-assessment meets the criteria, at block 660 the system may create a vendor approval package in the system at block 665. The vendor package may be reviewed again at block 670 and the system may determine whether the package is approved at block 670. If the package is approved, it may be saved in the system at block 675.

If the self-assessment fails the criteria in block 655, a message may be communicated to the customer at block 680 and at block 685 the system may communicate a correction request to the vendor. The assessment may take on a variety of forms.

In one embodiment, a relevance score of the uploaded documents which may be referred to as upload documents may be determined with respect to the control. The control may be a document or contract that has been previously reviewed and may be determined to have the desired elements. The control may be defined as mandatory or optional and the elements may be mandatory or optional. The control may have a mandatory document upload requirement for documents considered of high importance. In other words, a vendor may not be able to self-certify as to certain elements and it may be mandatory to upload documents to satisfy certain elements. A single document may be used for multiple controls. The controls may have weights and compliance may be determined based on a weighted score of compliance.

Logically, the relevance of a uploaded document may be compared to a control objective. In some embodiments, each control may be associated with a normalized search query defined to search for relevant search terms, phrases or concepts. In some an embodiment, an exact match may not be required to illustrate that an element is present in a contract/document. For example, a normalized search query may search for subject-predicate-object tuples.

A match score may be determined where the match score may be a measure of the documents relevance where the terms from the document are compared to desired text using at least one of exact text, n-ary expressions, search with stemming, search with synonyms and search with minor errors. The match score may also include comparing the document manual thesaurus incorporating broader/generic and narrower/specific terms in addition to the preferred terms and synonyms/The comparison may include comparing the contract language to a controlled vocabulary with a canonical term for each concept in the contract. In other embodiments, the comparison further includes auto-generating a thesaurus based on co-occurrence statistics. In yet another embodiment, the document comparison may include acquiring large vendor document-base and analyzing the document base using a concept identification algorithm. Further, the comparison may include executing a term occurrence analysis algorithm and assigning a weight assignment to certain terms for documents deemed relevant per associated control type. In yet another embodiment, a concept linking algorithm may be executed to go beyond the matching on broader/narrower sense of terms/phrases to find known associations per control type where the control type may include a NLP techniques such as POS tagging or entity recognition in the text content. The comparison may further include clustering for discovering similar documents (including the assessment of relevance as a feature), on the fly and creating a vector of topics to be used to measure the relevance of new documents.

The comparison may be a learning algorithm. For example, large data sets of previously analyzed contracts may be reviewed and the contracts may be mined for association rules and concept correlation. For example, a set of documents may be split into 4 groups. One group may be used to test an algorithm and the other three groups may be used to train the algorithm. Once the training is complete, the groups may rotate places and the previous test group may become a training group and one of the training group may become the test group. The trained algorithm may then be used to evaluate new contracts received in the future.

Referring again to FIG. 6, the vendor may receive the correction request at block 688, may revise the response to the questionnaire at block 689 and may initiate a correction review at block 690. The system may receive corrected materials at block 691 and the materials may be re-scored by the system at block 693. The corrected score may then by communicated to the user at block 695. If the score is still below the criteria, the steps 680-695 may repeat until the vendor scores over the criteria threshold. If the vendor is unable to provide additional materials, the user may make a decision whether to accept the risk of the vendor. If the risk is not acceptable, a message may be communicated from the customer to the vendor at block 699 and a new vendor may be located. If the risk is acceptable, the system may create a vendor approval package in the system as described with respect to blocks 660-675. More specifically, the vendor package may be reviewed again at block 670 and the system may determine whether the package is approved. If the package is approved, it may be saved in the system at block 675.

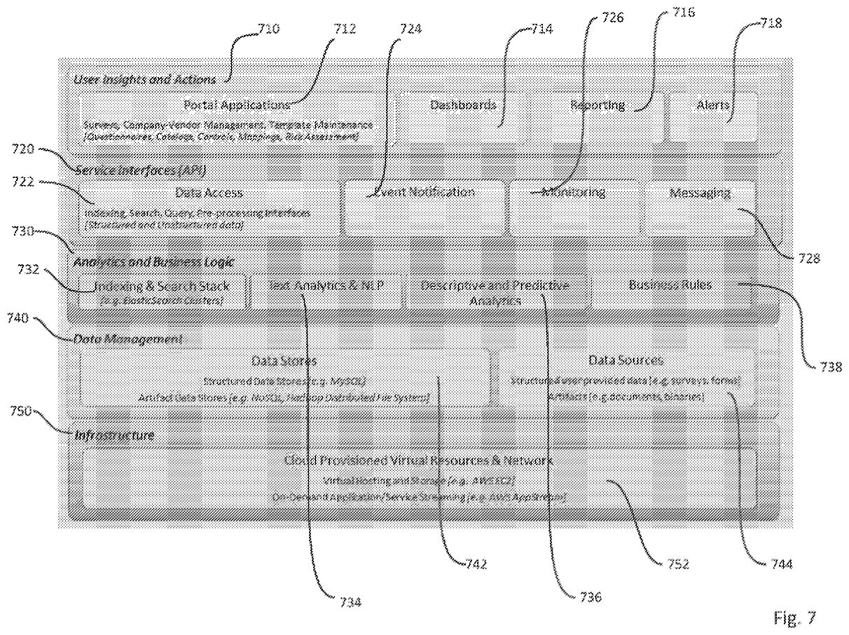

Looking at the system from another perspective as illustrated in FIG. 7, there may be a plurality of computing levels to be considered. The highest level 710 may be user insights and actions. From a user interface perspective, the system may have a plurality of applications 712. The applications may be on separate servers which may be specifically built to execute the applications. In other embodiments, a single server may execute the various aspects of the applications. In yet a further embodiment, a server may have a plurality of processors with the processors being assigned specific aspects. The applications may include applications for surveys, company-vendor management, template maintenance such as maintaining questionnaires, catalogs, controls, mapping, risk assessments, etc. The user insights may include dashboards 714, reporting applications 716 and applications to provide alerts 718.

At another level 720, the system may provide service interfaces such as application program interfaces (APIs). The APIs may ease the ability to efficiently and reliably communicate data to the system. There may be an API that covers data access 722 such as indexing, searching, querying and pre-processing interfaces for structured and unstructured data. There may also be APIs for event notification 724, monitoring 726 and messaging 728. The APIs may have specific fields in specific places in specific formats such that communicating with the applications will be known. By having the API be set, other applications may be able to easily work with the system and applications to provide even more options for using the system. Related there may be a data structures to govern the manner of storing and communicating data such that the data may be efficiently understood and communicated.

At another level 730, analytics and business logic may be provided. The analytics and business logic may allow for indexing and search stack operations 732 such as an elastic search cluster. The analytics and business logic may also include text analytics and natural language processing (NLP) 734, descriptive and predictive analytics 736 and business rules 738.

At yet another level 740, the system manage data. The data management may include data stores 742 such as structured data stores such as my SQL and may also include artifact data stores such as NoSQL or Hadoop distributed file systems. Data sources 744 also may be in this level with structured user provided data such as surveys and forms along with artifacts such as documents and binaries.

At yet another level 750, an infrastructure layer may be provided. The infrastructure may assist in the cloud provisioned virtual resources and network part of the system 752. For example, the virtual hosting and storage aspects of the system may be controlled at this level. In addition, on-demand applications and service streaming such as Amazon Web Services App Stream may be controlled at this level.

The manner of saving the data may occur in a variety of ways. In some embodiments, the data may be stored in a database for easy access and review. In some embodiments, the data may be encrypted for security. In other embodiments, the data may be stored in a cloud based storage system such that the data may be easily accessed by a variety of users using a variety of computing device from a variety of locations.

In other embodiments, the data may be stored in a blockchain format. Blockchain uses a distributed database or ledger that is used to maintain a continuously growing list of records, called blocks. Each block may contain a timestamp and a link to a previous block. A blockchain may be typically managed by a peer-to-peer network collectively adhering to a protocol for validating new blocks. By design, blockchains may be inherently resistant to modification of the data. Once recorded, the data in any given block may not be altered retroactively without the alteration of all subsequent blocks and a collusion of the network majority. Functionally, a blockchain may serve as “an open, distributed ledger that can record transactions between two parties efficiently and in a verifiable and permanent way. Many users may have copies of the ledger. When information is added to the ledger, information from older entries to the ledger may be compared among the copies of the ledger to ensure the new information belongs in the ledger. The information may then be stored in the various ledgers and the blockchain grows. The advantage of blockchain may be the security and the lack of a need for a centralized authority.

In this implementation, the data for the vendors may be stored in the blockchain. The increase in security may be useful in thwarting attempts to impermissibly manipulate the data. The distributed nature of the data storage may provide comfort to both user and vendors. User may be confident that the data will not be hacked by attacking a central storage location that may be the responsibility of the user. Vendors may be comforted that their data may be safe from being hacked.

By using blockchain, several technical problems may be addressed. Logically, the data may be safer and harder to hack as a result of it being stored in a blockchain. In addition, the blockchain may be more secure than a traditional database. Finally, the software to enable the blockchain may be technically sophisticated and specifically adapted to the needs of the system.

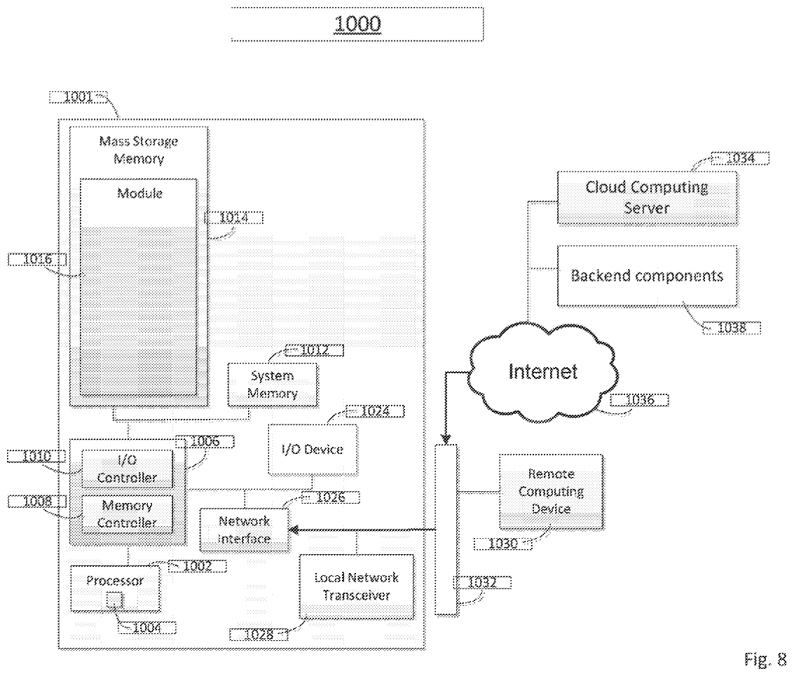

FIG. 8 is a high-level block diagram of an example computing environment 1000 for the system 100 and method for purchasing and returning items in a checkout-free store, as described herein. The computing device 1001 may include a server (e.g., the payment processing server, a mobile computing device (e.g., user computing device), a cellular phone, a tablet computer, a Wi-Fi-enabled device or other personal computing device capable of wireless or wired communication), a thin client, or other known type of computing device. As will be recognized by one skilled in the art, in light of the disclosure and teachings herein, other types of computing devices can be used that have different architectures. Processor systems similar or identical to the example systems and methods described herein may be used to implement and execute the example systems of FIG. 1 and methods of FIGS. 3A and 3B. Although the example system 1000 is described below as including a plurality of peripherals, interfaces, chips, memories, etc., one or more of those elements may be omitted from other example processor systems used to implement and execute the example systems and methods. Also, other components may be added.

As shown in FIG. 8, the computing device 1001 includes a processor 1002 that is coupled to an interconnection bus. The processor 1002 includes a register set or register space 1004, which is depicted in FIG. 10 as being entirely on-chip, but which could alternatively be located entirely or partially off-chip and directly coupled to the processor 1002 via dedicated electrical connections and/or via the interconnection bus. The processor 1002 may be any suitable processor, processing unit or microprocessor. Although not shown in FIG. 8, the computing device 1001 may be a multi-processor device and, thus, may include one or more additional processors that are identical or similar to the processor 1002 and that are communicatively coupled to the interconnection bus.

The processor 1002 of FIG. 8 is coupled to a chipset 1006, which includes a memory controller 1008 and a peripheral input/output (I/O) controller 1010. As is well known, a chipset typically provides I/O and memory management functions as well as a plurality of general purpose and/or special purpose registers, timers, etc. that are accessible or used by one or more processors coupled to the chipset 1006. The memory controller 1008 performs functions that enable the processor 1002 (or processors if there are multiple processors) to access a system memory 1012 and a mass storage memory 1014, that may include either or both of an in-memory cache (e.g., a cache within the memory 1012) or an on-disk cache (e.g., a cache within the mass storage memory 1014).

The system memory 1012 may include any desired type of volatile and/or non-volatile memory such as, for example, static random access memory (SRAM), dynamic random access memory (DRAM), flash memory, read-only memory (ROM), etc. The mass storage memory 1014 may include any desired type of mass storage device. For example, the computing device 1001 may be used to implement a module 1016 (e.g., the various modules as herein described). The mass storage memory 1014 may include a hard disk drive, an optical drive, a tape storage device, a solid-state memory (e.g., a flash memory, a RAM memory, etc.), a magnetic memory (e.g., a hard drive), or any other memory suitable for mass storage. As used herein, the terms module, block, function, operation, procedure, routine, step, and method refer to tangible computer program logic or tangible computer executable instructions that provide the specified functionality to the computing device 1001, the system 100, and method 300. Thus, a module, block, function, operation, procedure, routine, step, and method can be implemented in hardware, firmware, and/or software. In one embodiment, program modules and routines are stored in mass storage memory 1014, loaded into system memory 1012, and executed by a processor 1002 or can be provided from computer program products that are stored in tangible computer-readable storage mediums (e.g. RAM, hard disk, optical/magnetic media, etc.).

The peripheral I/O controller 1010 performs functions that enable the processor 1002 to communicate with a peripheral input/output (I/O) device 1024, a network interface 1026, a local network transceiver 1028, (via the network interface 1026) via a peripheral I/O bus. The I/O device 1024 may be any desired type of I/O device such as, for example, a keyboard, a display (e.g., a liquid crystal display (LCD), a cathode ray tube (CRT) display, etc.), a navigation device (e.g., a mouse, a trackball, a capacitive touch pad, a joystick, etc.), etc. The I/O device 1024 may be used with the module 1016, etc., to receive data from the transceiver 1028, send the data to the components of the system 100, and perform any operations related to the methods as described herein.

The local network transceiver 1028 may include support for a Wi-Fi network, Bluetooth, Infrared, cellular, or other wireless data transmission protocols. In other embodiments, one element may simultaneously support each of the various wireless protocols employed by the computing device 1001. For example, a software-defined radio may be able to support multiple protocols via downloadable instructions. In operation, the computing device 1001 may be able to periodically poll for visible wireless network transmitters (both cellular and local network) on a periodic basis. Such polling may be possible even while normal wireless traffic is being supported on the computing device 1001. The network interface 1026 may be, for example, an Ethernet device, an asynchronous transfer mode (ATM) device, an 802.11 wireless interface device, a DSL modem, a cable modem, a cellular modem, etc., that enables the system 100 to communicate with another computer system having at least the elements described in relation to the system 100.

While the memory controller 1008 and the I/O controller 1010 are depicted in FIG. 10 as separate functional blocks within the chipset 1006, the functions performed by these blocks may be integrated within a single integrated circuit or may be implemented using two or more separate integrated circuits. The computing environment 1000 may also implement the module 1016 on a remote computing device 1030. The remote computing device 1030 may communicate with the computing device 1001 over an Ethernet link 1032. In some embodiments, the module 1016 may be retrieved by the computing device 1001 from a cloud computing server 1034 via the Internet 1036. When using the cloud computing server 1034, the retrieved module 1016 may be programmatically linked with the computing device 1001. The module 1016 may be a collection of various software platforms including artificial intelligence software and document creation software or may also be a Java® applet executing within a Java® Virtual Machine (JVM) environment resident in the computing device 1001 or the remote computing device 1030. The module 1016 may also be a “plug-in” adapted to execute in a web-browser located on the computing devices 1001 and 1030. In some embodiments, the module 1016 may communicate with back end components 1038 via the Internet 1036.

The system 1000 may include but is not limited to any combination of a LAN, a MAN, a WAN, a mobile, a wired or wireless network, a private network, or a virtual private network. Moreover, while only one remote computing device 1030 is illustrated in FIG. 10 to simplify and clarify the description, it is understood that any number of client computers are supported and can be in communication within the system 1000.

Additionally, certain embodiments are described herein as including logic or a number of components, modules, or mechanisms. Modules may constitute either software modules (e.g., code or instructions embodied on a machine-readable medium or in a transmission signal, wherein the code is executed by a processor) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “an embodiment” or “teaching” means that a particular element, feature, structure, or characteristic described in connection with the embodiment is included in at least one embodiment. The appearances of the phrase “in some embodiments” or “teachings” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Further, the figures depict preferred embodiments for purposes of illustration only. One skilled in the art will readily recognize from the following discussion that alternative embodiments of the structures and methods illustrated herein may be employed without departing from the principles described herein

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

1. A computer based method of verification comprising:
communicating a self-assessment request to a vendor;
receiving a self-assessment response from the vendor, the self-assessment response including a self-assessment;
in response to the self-assessment being acceptable,
determining whether the vendor is due for a random audit;
in response to the random audit being determined to be due,
beginning the random audit comprising:
receiving an upload document;
reviewing the upload document;
noting exceptions;
updating user dashboard; and
in response to the random audit not being determined to be due,
updating a user dashboard.

2. The computer based method of verification of claim 1, wherein the self-assessment response comprises answering questions regarding conformance with a control.

3. The computer based method of verification of claim 2, wherein the self-assessment further comprises uploading upload documents in complying with the control.

4. The computer based method of verification of claim 3, further comprising determining a relevance score of the upload documents with respect to the control.

5. The computer based method of verification of claim 2, wherein the control may be defined as mandatory or optional.

6. The computer based method of verification of claim 2, wherein the control may have a mandatory document upload requirement.

7. The computer based method of verification of claim 2, wherein a single upload document may be used for multiple controls.

8. The computer based method of verification of claim 2, wherein controls may have weights and compliance may be determined based on a weighted score of compliance.

9. The computer based method of verification of claim 2, wherein relevance of the upload document is compared to a control objective.

10. The computer based method of verification of claim 2, wherein each of the controls is associated with a normalized search query defined to search for relevant search terms, phrases or concepts.

11. The computer based method of verification of claim 1, wherein a normalized search query searches for subject-predicate-object tuples.

12. The computer based method of verification of claim 3, wherein a match score is determined wherein the match score comprises a measure of a relevance of the upload document wherein terms from the upload document are compared to desired text to create a comparison using at least one of:
exact text;
n-ary expressions;
search with stemming;
search with synonyms; and
search with minor errors.

13. The computer based method of verification of claim 12, wherein the match score comprises:
creating a comparison of the upload document to a manual thesaurus incorporating broader/generic and narrower/specific terms in addition to preferred terms and synonyms.

14. The computer based method of verification of claim 12, wherein the comparison further comprises comparing upload document language to a controlled vocabulary with a canonical term for each concept in the upload document.

15. The computer based method of verification of claim 12, wherein the comparison further comprises auto-generating a thesaurus based on co-occurrence statistics.

16. The computer based method of verification of claim 12, wherein the comparison of the upload document further comprises:
acquiring a large vendor document base; and
analyzing the document base using a concept identification algorithm.

17. The computer based method of verification of claim 1, further comprising executing a term occurrence analysis algorithm and assigning a weight assignment to certain terms for upload documents deemed relevant per associated control type.

18. The computer based method of verification of claim 1, further comprising executing a concept linking algorithm to go beyond matching on broader/narrower sense of terms/phrases to find known associations per control type using NLP techniques including POS tagging or entity recognition in text content of the upload document.

19. The computer based method of verification of claim 1, further comprising:
clustering for discovering similar upload documents including an assessment of relevance as a feature, on the fly; and
creating a vector of topics to be used to measure relevance of new upload documents.

20. The computer based method of verification of claim 1, further comprising:
reviewing large data sets of previously analyzed upload documents; and
mining the previously analyzed upload documents for association rules and concept correlation.
